(19) United States
(12) Patent Application Publication
(10) Pub. No.: US 2021/0170333 A1
(43) Pub. Date: Jun. 10, 2021

(54) Method And Apparatus For Dehydration Of Biomass

(71) Applicant: Kiinja Corporation, Fort Collins, CO (US)

(72) Inventors: Gregory A. Jackson, Livermore, CO (US); Michael D. Hake, Greeley, CO (US); Michael S. Harris, Livermore, CO (US)

(73) Assignee: Kiinja Corporation, Fort Collins, CO (US)

(21) Appl. No.: 17/118,198

(22) Filed: Dec. 10, 2020

Related U.S. Application Data
(60) Provisional application No. 62/946,087, filed on Dec. 10, 2019.

(51) Int. Cl. B01D 53/84

(52) U.S. Cl. CPC B01D 53/84

(57) ABSTRACT

A method and corresponding dehydration apparatus, whereby the method includes disposing an amount of biomass in a pressurizable chamber, generating a sub-atmospheric pressure in the chamber, and vaporizing water associated with the biomass to produce dehydrated biomass.

This U.S. Non-Provisional patent application claims the benefit of U.S. Provisional Patent Application No. 62/946,087, filed Dec. 10, 2019, hereby incorporated by reference herein.

### I. BRIEF SUMMARY OF THE INVENTION

A broad object of a particular embodiment of the invention can be to provide a method and corresponding dehydration apparatus, whereby the method includes disposing an amount of biomass in a pressurizable chamber, generating a sub-atmospheric pressure in the chamber, and vaporizing water associated with the biomass to produce dehydrated biomass.

Naturally, further objects of the invention are disclosed throughout other areas of the specification, drawings, and claims.

### II. BRIEF DESCRIPTION OF THE DRAWINGS

FIG. 1 is an illustration of the instant dehydration apparatus which may be used in conjunction with the instant method of dehydrating biomass, whereby a relatively large amount of biomass can be loaded into a pressurizable chamber located within a vessel disposed in a vessel first position.

FIG. 2 is an illustration of the dehydration apparatus shown in FIG. 1, but whereby the vessel disposes in a vessel second position and a cover configured to close the chamber disposes in a cover first position above the chamber.

FIG. 3 is an illustration of the dehydration apparatus shown in FIG. 2, but whereby the cover disposes in a cover second position to close the chamber. Once closed, a sub-atmospheric pressure can be generated within the chamber to vaporize water associated with the biomass, whereby thermal energy can be added to the chamber to facilitate the vaporization of the water. Additionally, tile water vapor can be collected by a vapor collector, which can be coupled to the cover.

FIG. 4 is an illustration of the dehydration apparatus shown in FIG. 3, but whereby the cover disposes in a cover first position above the chamber following release of the vacuum within the chamber.

FIG. 5 is an illustration of the dehydration apparatus shown in FIG. 4, but whereby the vessel disposes in the vessel first position to permit movement of a collection reservoir relative to the cover and vapor collector coupled thereto.

FIG. 6 is an illustration of the dehydration apparatus shown in FIG. 5, but whereby the collection reservoir disposes below the cover and vapor collector to allow the collection of melted water from the vapor collector into the collection reservoir.

FIG. 7 is an illustration of the dehydration apparatus shown in FIG. 6, but whereby the vessel disposes in an unloading position, which may be useful for unloading the dehydrated biomass from the chamber.

FIG. 8A is a front perspective view of an embodiment of a vessel of the instant dehydration apparatus, whereby an agitator is disposed with the chamber of the vessel.

FIG. 8B is a rear perspective view of the embodiment of the vessel shown in FIG. 8A.

FIG. 8C is a front view of the embodiment of the vessel shown in FIG. 8A.

FIG. 8D is a rear view of the embodiment of the vessel shown in FIG. 8A.

FIG. 8E is a first side view of the embodiment of the vessel shown in FIG. 8A.

FIG. 8F is a second side view of the embodiment of the vessel shown in FIG. 8A.

FIG. 8G is a top view of the embodiment of the vessel shown in FIG. 8A.

FIG. 8H is a bottom view of the embodiment of the vessel shown in FIG. 8A.

FIG. 9A is a front and top perspective view of an embodiment of a cover of the instant dehydration apparatus.

FIG. 9B is a rear and top perspective view of the embodiment of the cover shown in FIG. 9A.

FIG. 9C is a front and bottom perspective view of the embodiment of the cover shown in FIG. 9A.

FIG. 9D is a rear and bottom perspective view of the embodiment of the cover shown in FIG. 9A.

FIG. 9E is a front view of the embodiment of the cover shown in FIG. 9A.

FIG. 9F is a rear view of the embodiment of the cover shown in FIG. 9A.

FIG. 9G is a first side view of the embodiment of e cover shown in FIG. 9A.

FIG. 9H is a second side view of the embodiment of the cover shown in FIG. 9A.

FIG. 9I is a top view of the embodiment of the cover shown in FIG. 9A.

FIG. 9J is a bottom view of the embodiment of the cover shown in FIG. 9A.

FIG. 10 is a cross-sectional view of a particular embodiment of a pressurizable chamber and a cover of the instant dehydration apparatus, whereby a condensate collector configured to collect liquid water from the vapor collector can be seen disposed within the chamber, the condensate collector in fluid communication with a condensate outlet port and a collection reservoir.

FIG. 11 is a cross-sectional view of a particular embodiment of a pressurizable chamber and a cover of the instant dehydration apparatus, whereby an agitator and vapor collector can be seen disposed within the chamber.

FIG. 12 is a flow diagram depicting particular embodiments of the instant method for dehydrating biomass.

FIG. 13 is a front perspective view of an embodiment of a vessel of the instant dehydration apparatus, whereby a spacer is disposed with the chamber of the vessel.

FIG. 14A is an exploded front perspective view of the embodiment of the vessel and spacer shown in FIG. 13.

FIG. 14B is an enlarged view of a portion of the spacer shown in FIG. 14A.

### III. DETAILED DESCRIPTION OF THE INVENTION

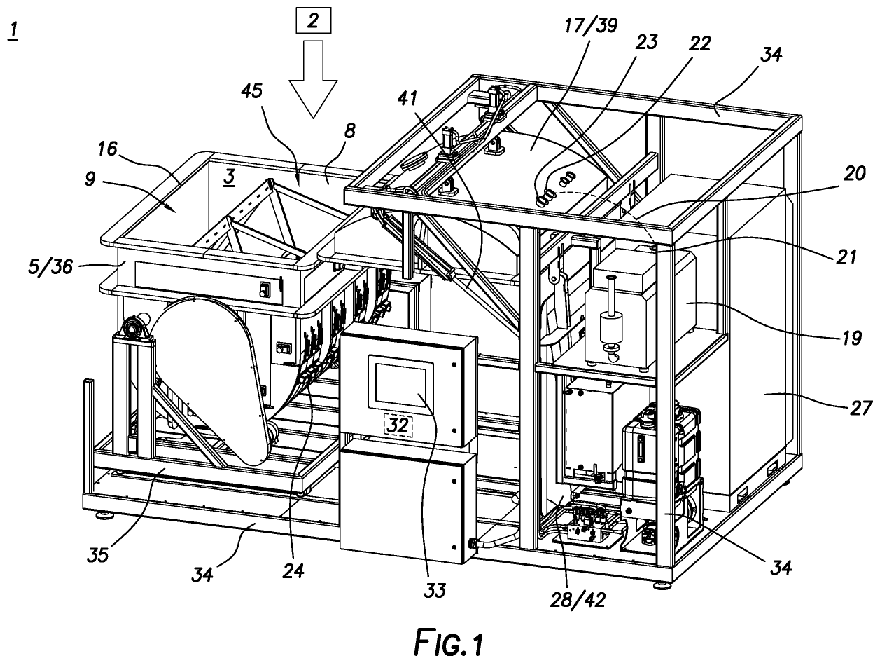

Now referring primarily to FIGS. 1-7 and FIG. 12, which illustrate one or more methods and corresponding dehydration apparatuses (1) for dehydrating biomass (2) to a desired moisture content, whereby the method generally includes disposing an amount of biomass (2) in a pressurizable chamber (3), generating a sub-atmospheric pressure within the chamber (3), and vaporizing water associated with the biomass (2) to produce dehydrated biomass (4).

As used herein, the term “biomass” means organic material derived from plants and/or animals. As to particular embodiments, the instant dehydration process may be especially useful for dehydrating plant (or botanical) biomass.

As to particular embodiments, the instant dehydration process may be especially useful for dehydrating cannabis plant biomass, whereby the term “cannabis plant” can encompass plants (and any parts thereof) in the Cannabis genus and, without limitation to the breadth of the foregoing, can include Cannabis sativa, Cannabis indica, and Cannabis ruderalis along with variants and strains resulting from genetic crosses, self-crosses, or hybrids thereof, or genetically modified or engineered strains.

As to other particular embodiments, the instant dehydration process may be especially useful for dehydrating vanilla orchid (Vanilla planifolia) biomass, such as vanilla beans.

As used herein, the term “vaporization” and variations thereof mean a phase transition from a liquid to a vapor.

Now referring primarily to FIG. 12, to produce the dehydrated biomass (4), the method can include extracting water from the bio-nass (2) by vaporization (or by converting liquid water present in the biomass (2) to water vapor), whereby at least this step can differentiate the instant method from lyophilization, which mandates freezing the matter to be dehydrated and subsequently extracting water from the biomass (2) by sublimation (or by converting solid water present in the biomass (2) to water vapor).

As to particular embodiments, the method can further include providing a sufficient amount of thermal energy to the chamber (3) to vaporize the water associated with the biomass (2).

As to particular embodiments, the method can further include heating the chamber (3) to a relatively low temperature to vaporize the water associated with the biomass (2). Said another way, the method can further include heating the chamber (3) to a temperature effective to vaporize the water associated with the biomass (2), whereby the temperature can be a relatively low temperature such as a temperature of less than 150° F. Notably, by minimizing the temperature to which the biomass (2) is exposed during the dehydration process, the instant method may preclude adversely affecting one or more heat-sensitive constituents of the dehydrated biomass (4).

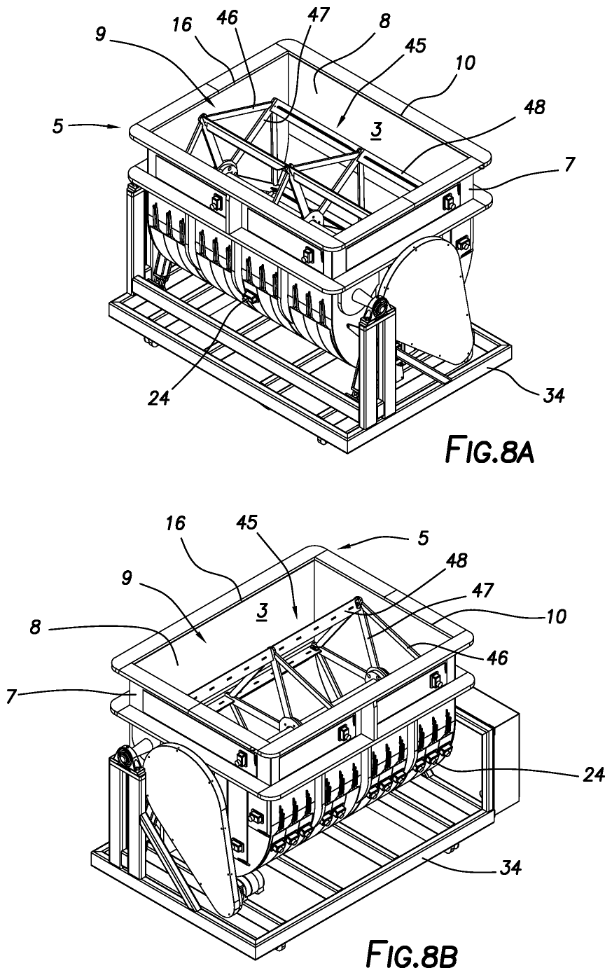

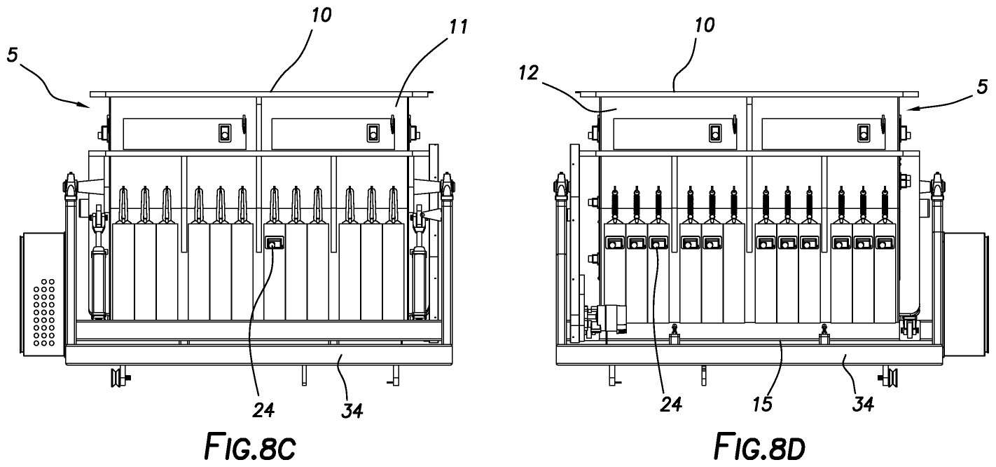

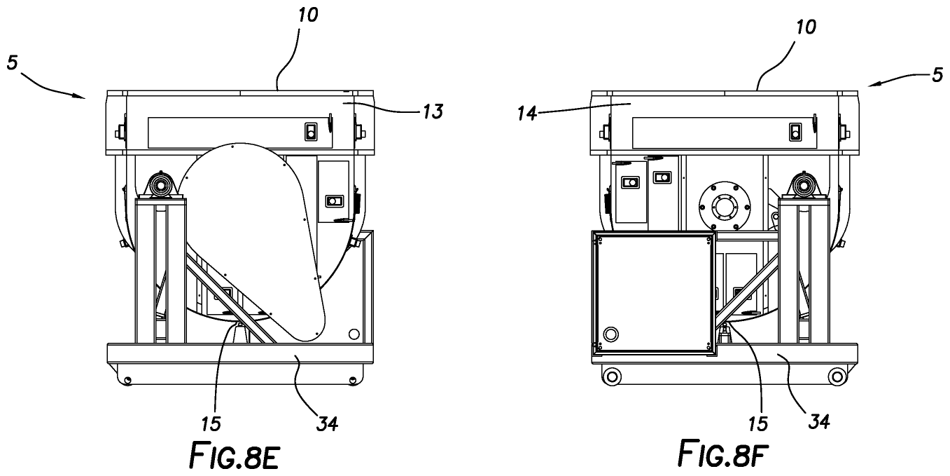

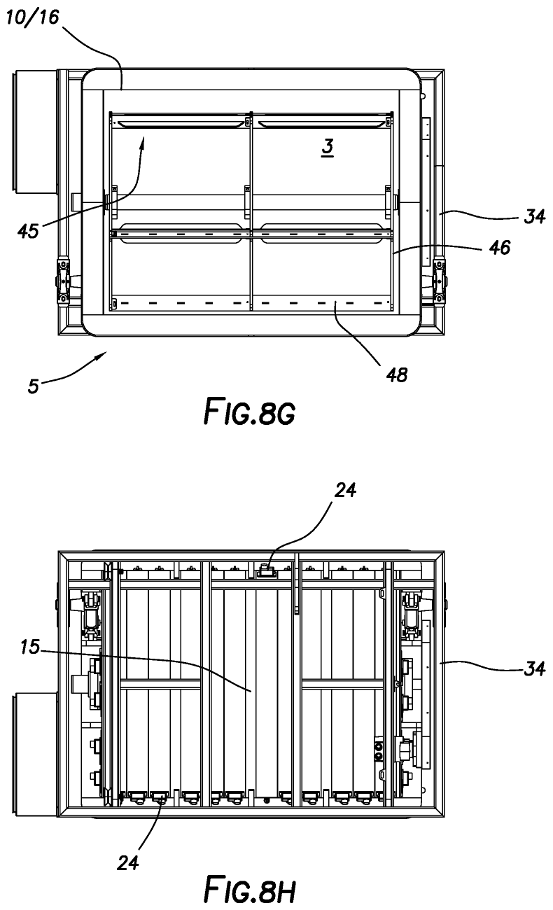

Now referring primarily to FIGS. 8A through 8H, the dehydration apparatus (1) includes a vessel (5) having a wall disposed between vessel external and internal surfaces (7)(8). The vessel internal surface (8) defines a pressurizable chamber (3) which communicates with a vessel opening (9) through which matter can be passed for ingress into or egress from the chamber (3). As to particular embodiments, the vessel opening (9) can be disposed proximate a vessel top portion (10) and can communicate with a chamber (3) located therebelow, whereby the wall can laterally surround the chamber (3).

Now referring primarily to FIG. 8G, the wail can provide opposing vessel first and second sides (11)(12) which can be coupled or joined together by opposing vessel first and second ends (13)(14). As to particular embodiments, the vessel first and second sides (11)(12) can be arcuate (as opposed to planar or flat) and correspondingly, can provide a concave vessel internal surface (8) which partly defines the chamber (3). Further, as to particular embodiments, the arcuate vessel first and second sides (11)(12) can join together or be integrated to provide a closed vessel bottom portion (15).

Regarding dimensions, as but one illustrative example, the vessel (5) can have a length disposed between the opposing vessel first and second ends (13)(14) in a range of between about 53 inches and about 63 inches, a width disposed between the opposing vessel first and second sides (11)(12) in a range of between about 39.5 inches and about 49.5 inches, and a height disposed between the vessel top and bottom portions (10)(15) in a range of between about 39.5 inches and about 49.5 inches. Note that these dimensions are relatively large, which may permit the instant vessel (5) and corresponding chamber (3) to be used for relatively large-scale and/or high-throughput processing. For example, such a vessel (5) may be able to contain as much as 1,000 pounds of wet biomass (2), thus permitting dehydration of the same during a single processing event.

Of course, the dimensions of the vessel (5) need not be limited to the above, and both smaller and larger vessels (5) may be useful for the instant method of dehydrating biomass (2), depending upon the desired input of biomass (2) and/or output of dehydrated biomass (4).

Further regarding dimensions, the wall of the vessel (5) can have a thickness disposed between the vessel external and internal surfaces (7)(8) in a range of between about ⅛ of an inch and about ½ of an inch. Naturally, the thickness of the wall need not be limited to the above, but the wall's thickness must be sufficient to provide adequate strength to withstand the pressure differential created between the external atmospheric pressure and the sub-atmospheric pressure generated within the chamber (3) during the dehydration process.

Concerning construction, the vessel (5) can be formed from a numerous and wide variety of material(s) which may be suitable for the intended purpose, so long as the final construct has the necessary strength to withstand the pressure differential created between the external atmospheric pressure and the sub-atmospheric pressure generated within the chamber (3) during the dehydration process. As but one illustrative example, the vessel (5) can be formed from stainless steel, which may be advantageous due to its corrosion resistant properties.

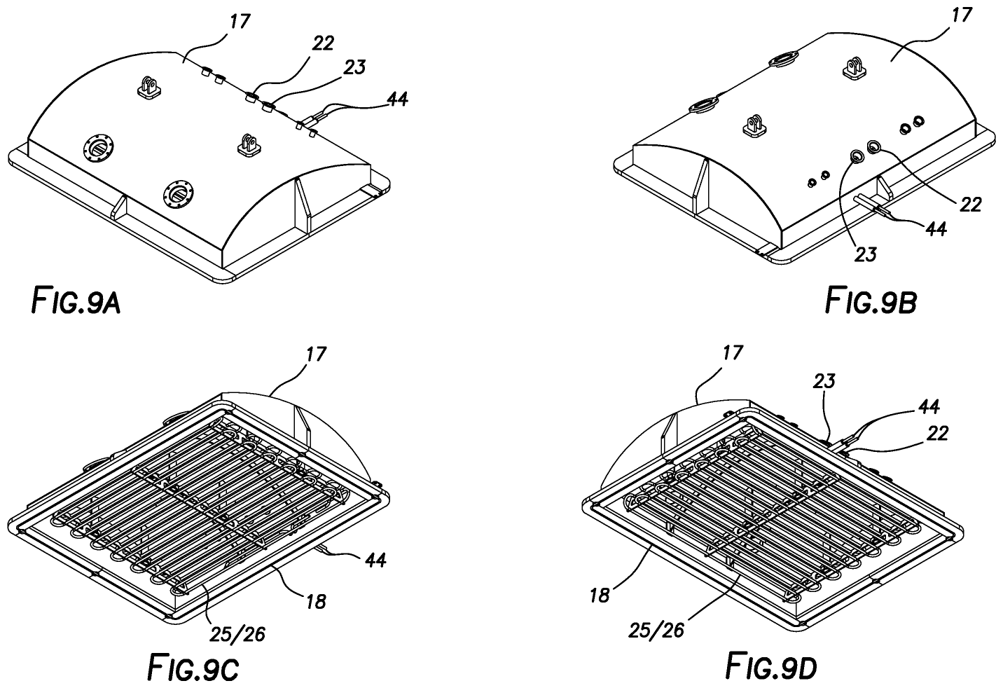

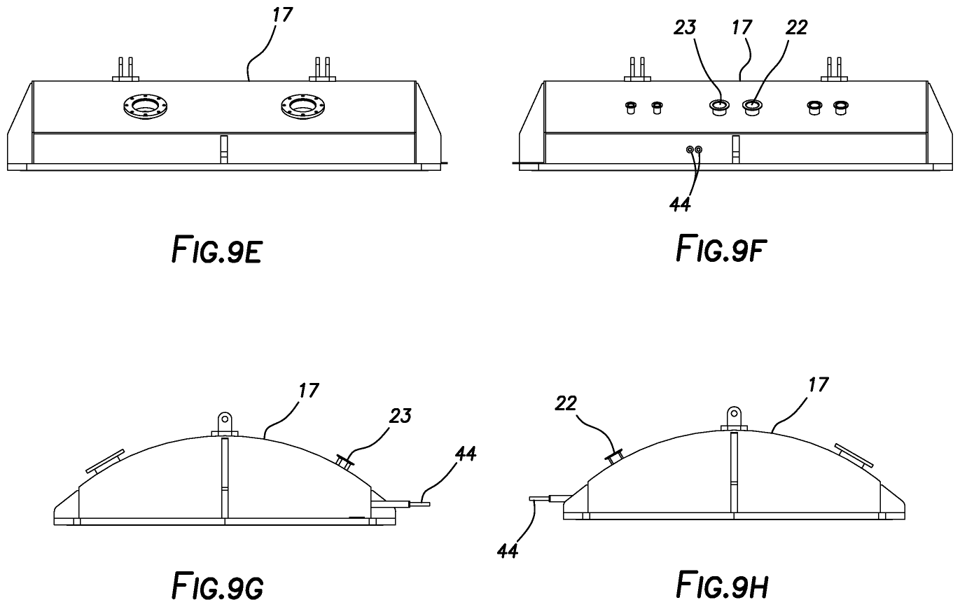

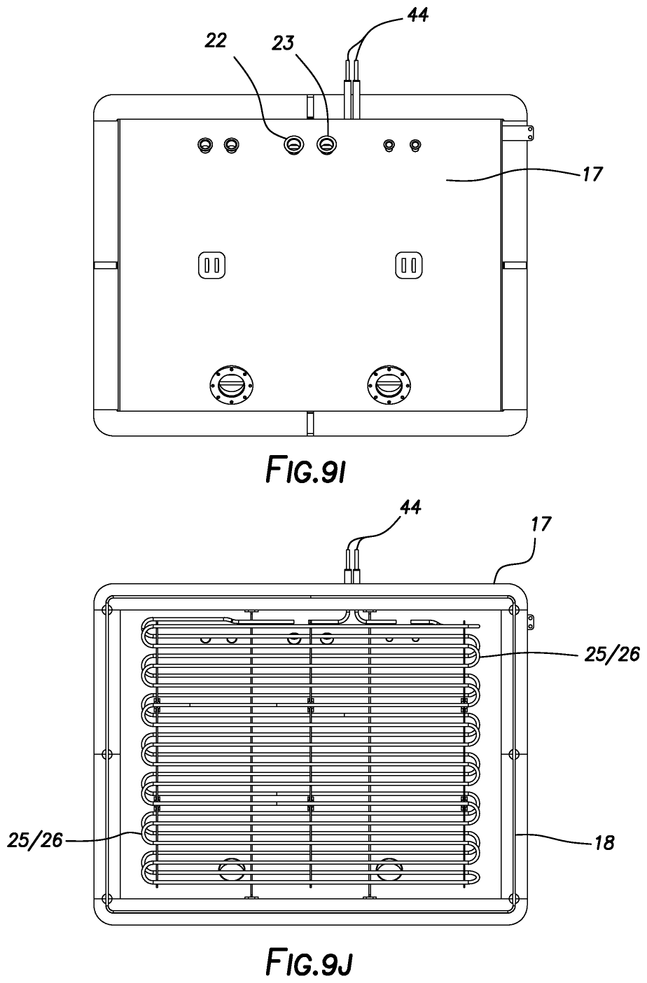

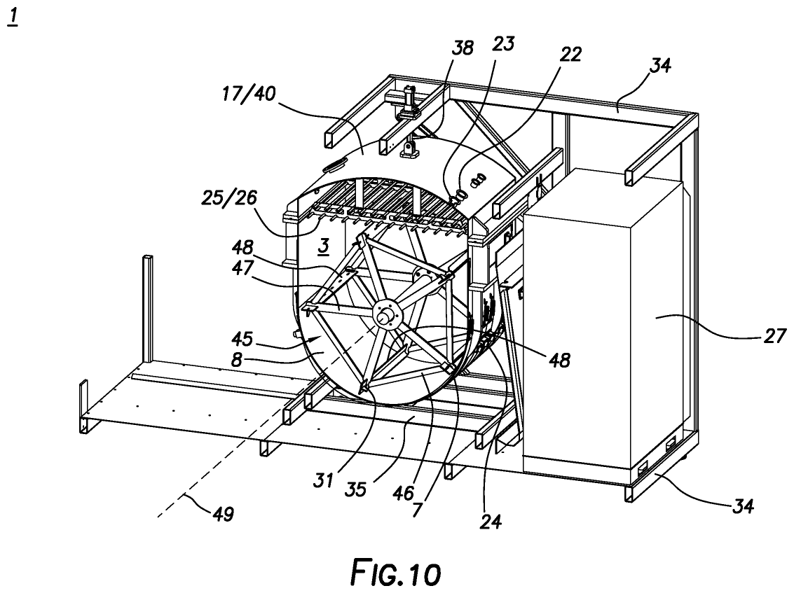

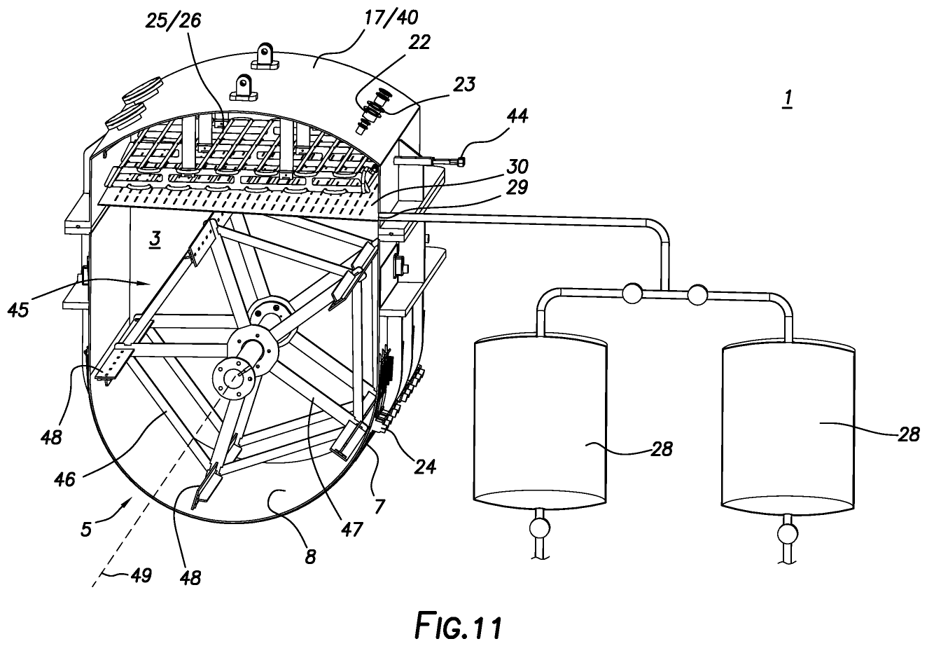

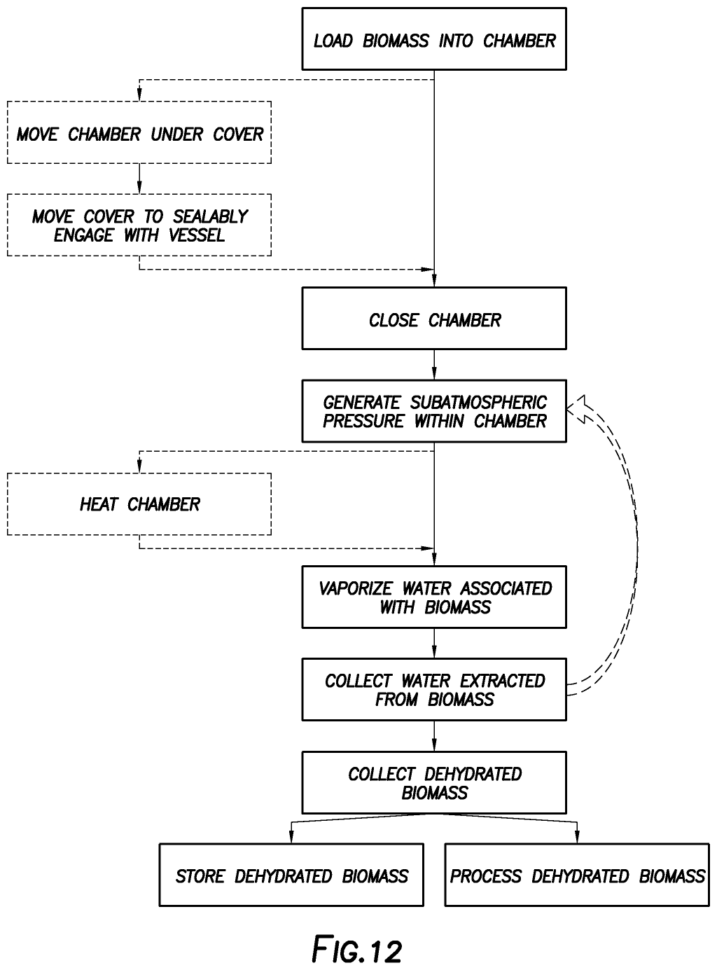

Now referring primarily to FIG. 8G and FIGS. 9A through 9J, the vessel top portion (10) terminates in an edge (16) which defines the vessel opening (9) that communicates with the chamber (3). The vessel opening (9) can be closed by a cooperating cover (17) which can sealably engage with vessel top portion (10) to (i) close the vessel opening (9) and correspondingly, provide a closed chamber (3), and (ii) form a hermetic seal.

Now referring primarily to FIGS. 9C, 9D, and 9J, the cover (17) can include a laterally-extending flange configured to abutting engage with a corresponding flange laterally extending from the vessel top portion (10) upon engagement of the cover (17) and the vessel (5). Additionally, a gasket (18) or mechanical seal, which may comprise a deformable material, can dispose between the laterally-extending flanges of the cover (17) and the vessel top portion (10), whereby upon engagement of the cover (17) and the vessel top portion (10), the gasket (18) can facilitate formation of a hermetic seal between the cover (17) and the vessel top portion (10). Moreover, upon the generation of a sub-atmospheric pressure within the chamber (3), the cover (17) may be further sealably engaged with the vessel top portion (10) by the external atmospheric pressure.

As to particular embodiments, the gasket (18) can be coupled to, connected to, or integrated with the laterally-extending flange of the cover (17) (as shown in the examples of the Figures). Alternatively, as to other particular embodiments, the gasket (18) can be coupled to, connected to, or integrated with the laterally-extending flange of the vessel top portion (10).

Now referring primarily to FIG. 3, the dehydration apparatus (1) can further include a vacuum generator (19) in fluid communication with (or fluidicly coupled to) the chamber (3), whereby the vacuum generator (19) can be configured to generate a sub-atmospheric pressure in the chamber (3). Concerning fluid communication, the vacuum generator (19) can be coupled to the chamber (3) via a first conduit (20) which extends between a vacuum generator port (21) and a first port (22) into the chamber (3). As shown in the examples of the Figures, the first port (22) can be disposed within the cover (17) but as might be expected, the first port (22) could alternatively be located in the wall of the vessel (5).

In operation, the vacuum generator (19) can decrease the pressure in the chamber (3) to a sub-atmospheric pressure, whereby this negative pressure can facilitate dehydration of the biomass (2) and in particular, can facilitate vaporization of water associated with the biomass (2). Following, water can be extracted from the biomass (2) and subsequently present in the chamber (3) as water vapor.

As to particular embodiments, the vacuum generator (19) can regulate the pressure within the chamber (3) to be a sub-atmospheric pressure, for example a pressure below 760 torr. As but one illustrative example, the vacuum generator (19) can generate a pressure within the chamber (3) of between about 759 torr and about 10 millitorr.

As but one illustrative example, a pressure which may be effective to practice the methods described herein can be about 30 torr at a temperature of about 80° F.

The vacuum generator (19) may be of any type which is adequate to sufficiently decrease the pressure in the chamber (3) to practice the methods described herein. As but one illustrative example, the vacuum generator (19) can be a PS Series Dry Screw Vacuum Pump, such as model PS80, available from Hanbell Precise Machinery Co., Ltd.

Concerning pressure release, in addition to the first port (22), a second port (23) can be in fluid communication with the chamber (3), whereby the second port (23) may be reversibly closable, for example via a valve. When closed, the second port (23) can preclude the equilibration of the sub-atmospheric pressure within the chamber (3) with the external atmospheric pressure. Contrarywise, when open, the second port (23) can allow the sub-atmospheric pressure within the chamber (3) to increase to equilibrate with the external atmospheric pressure.

Now referring primarily to FIGS. 8C and 8D, the dehydration apparatus (1) can further include a heat source (24) in thermal communication with the chamber (3), whereby the heat source (24) can be configured to control the temperature within the chamber (3). More specifically, the heat source (24) can be configured to provide thermal energy to the chamber (3) when biomass (2) is loaded therein and a sub-atmospheric pressure is generated.

As to particular embodiments, the heat source (24) can be located outside of the chamber (3). With regard to these particular embodiments, the heat source (24) can be in thermal communication with the vessel external surface (7). As but one illustrative example, the heat source (24) can be configured as one or more drum heaters (such as BriskHeat DHCS25, available from COLE-PARMER®) or one or more heating blankets (such as BriskHeat SRL06362PADJB-C, SRL18362PADJ-C, SRL06242PADJB-C, or SRL06122PADJB, all available from COLE-FARMER®), any of which can be thermally coupled to the vessel external surface (7). As but a second illustrative example, the heat source (24) can be configured as a conventional water jacket heating system.

As to other particular embodiments, the heat source (24) can be located inside of the chamber (3). As but one illustrative example of these embodiments, the heat source (24) can be configured as an infrared (IR) heat source.

Of course, the heat source (24) need not be limited to the above, and may be of any type which is suitable for providing thermal energy to the chamber (3) and its contents to practice the methods described herein.

As to particular embodiments, an important aspect of the instant invention can be to effectively dehydrate biomass (2) to a desired moisture content while maintaining a relatively low temperature within the chamber (3) during the dehydration process, which may be significant for preventing detriment to one or more heat-sensitive constituents of the dehydrated biomass (4). Said another way, an object of the present invention can be to effectively dehydrate biomass (2) without exposing the biomass (2) to a relatively high temperature which may adversely affect one or more heat-sensitive constituents of the dehydrated biomass (4). It is noted that at least this omission of high-temperature heating can differentiate the instant method from conventional dehydration processes which require exposure of the matter to be dehydrated to a relatively high temperature.

Without being bound by any particular theory, at a constant volume (such as the volume of the closed chamber (3)), a decrease in pressure results in a decrease in temperature. Consequently, at least an amount of thermal energy must be added to the closed chamber (3) to facilitate vaporization of water associated with the biomass (2).

As to particular embodiments, the heat source (24) can heat the chamber (3) to a temperature of not greater than 200° F. during the dehydration process.

As to particular embodiments, the heat source (24) can heat the chamber (3) to a temperature of not greater than 195° F. during the dehydration process.

As to particular embodiments, the heat source (24) can heat the chamber (3) to a temperature of not greater than 190° F. during the dehydration process.

As to particular embodiments, the heat source (24) can heat the chamber (3) to a temperature of not greater than 185° F. during the dehydration process.

As to particular embodiments, the heat source (24) can heat the chamber (3) to a temperature of not greater than 180° F. during the dehydration process.

As to particular embodiments, the heat source (24) can heat the chamber (3) to a temperature of not greater than 175° F. during the dehydration process.

As to particular embodiments, the heat source (24) can heat the chamber (3) to a temperature of not greater than 170° F. during the dehydration process.

As to particular embodiments, the heat source (24) can heat the chamber (3) to a temperature of not greater than 165° F. during the dehydration process.

As to particular embodiments, the heat source (24) can heat the chamber (3) to a temperature of not greater than 160° F. during the dehydration process.

As to particular embodiments, the heat source (24) can heat the chamber (3) to a temperature of not greater than 155° F. during the dehydration process.

As to particular embodiments, the heat source (24) can heat the chamber (3) to a temperature of not greater than 150° F. during the dehydration process.

As to particular embodiments, the heat source (24) can heat the chamber (3) to a temperature of not greater than 145° F. during the dehydration process.

As to particular embodiments, the heat source (24) can heat the chamber (3) to a temperature of not greater than 140° F. during the dehydration process.

As to particular embodiments, the heat source (24) can heat the chamber (3) to a temperature of not greater than 135° F. during the dehydration process.

As to particular embodiments, the heat source (24) can heat the chamber (3) to a temperature of not greater than 130° F. during the dehydration process.

As to particular embodiments, the heat source (24) can heat the chamber (3) to a temperature of not greater than 125° F. during the dehydration process.

As to particular embodiments, the heat source (24) can heat the chamber (3) to a temperature of not greater than 120° F. during the dehydration process.

As to particular embodiments, the heat source (24) can heat the chamber (3) to a temperature of not greater than 115° F. during the dehydration process.

As to particular embodiments, the heat source (24) can heat the chamber (3) to a temperature of not greater than 100° F. during the dehydration process.

As to other particular embodiments, an important aspect of the instant invention can be to effectively dehydrate biomass (2) to a desired moisture content, and provide a sufficient amount of heat to the chamber (3) and biomass (2) disposed therein to kill undesirable microorganisms, such as mold, bacteria, viruses, etc.

As to particular embodiments, the heat source (24) can heat the chamber (3) to a temperature of equal to or greater less than 250° F. during processing.

Now referring primarily to FIGS. 9C, 9D, 9J, 10, and 11, the dehydration apparatus (1) can further include a vapor collector (25) fluidicly coupled to the chamber (3), whereby the vapor collector (25) can be configured to collect the water vapor derived from the biomass (2).

As used herein, the term “vapor collector” means an apparatus, typically a machine, that is capable of collecting vapor, for example to remove vapor from a space.

As to particular embodiments, the vacuum generator (19) in fluid communication with the chamber (3) can function as the vapor collector (25). As but one illustrative example, this may be the case in a scenario whereby the vacuum generator (19) functions at a speed of about 10,000 L/min to generate a pressure of about 103.4 torr within the chamber (3), and the heat source (24) functions to heat the chamber (3) and the biomass (2) therewithin to about 125° F. (for example via about 33,500 Watts).

As to other particular embodiments, the vapor collector (25) can be configured as a condenser, which may include one or more coils (26) capable of being cooled, whereby the cooled coils (26) can extract water vapor from the chamber (3) during the dehydration process and specifically, when a sub-atmospheric pressure is generated within the chamber (3) and the water associated with the biomass (2) is vaporized. As shown in the examples of the Figures, a vapor collector (25) configured as a condenser can be coupled to the cover (17) but obviously, the condenser could alternatively be coupled to the wall of the vessel (5).

Concerning cooling, the coils (26) of the condenser can be fluidicly coupled to a chiller (27) by a port (44) which communicates between the coils (26) and the chiller (27). As but one illustrative example, the chiller (27) can be a cryocooler such as a POLYCOLD® system, whereby the chiller (27) can be configured to sufficiently cool the coils (26) to facilitate removal of the water vapor from the chamber (3) by the cooled coils (26).

As to particular embodiments, the coils (26) can be cooled sufficiently such that ice (solidified water) derived from the water vapor within the chamber (3) forms on the coiled coils (26). Following, the ice can be collected from the coils (26), thereby removing the water extracted from the biomass (2) from the chamber (3).

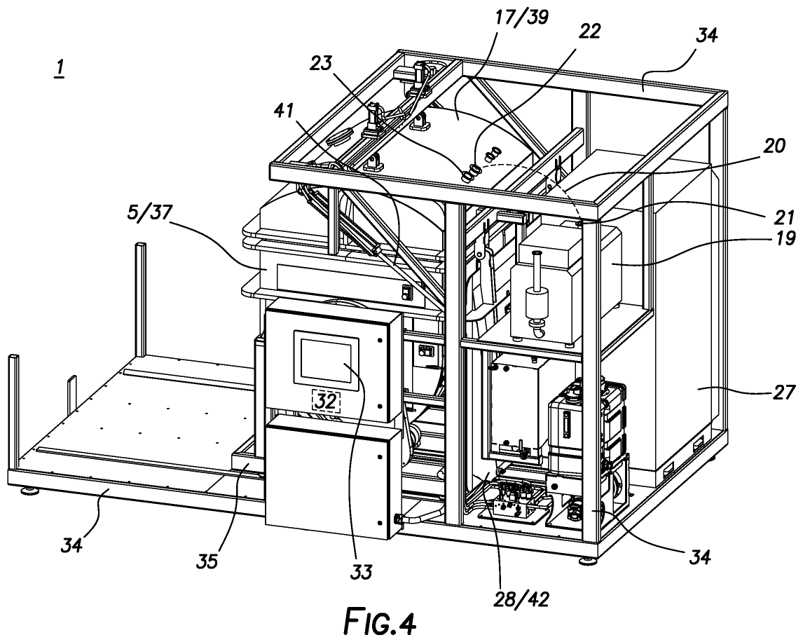

Now referring primarily to FIGS. 5 and 6, concerning the ice collection, as to particular embodiments, a collection reservoir (28) can be disposed under the cooled coils (26) and subsequently, the coils (26) can be heated such that the ice melts from the coils (26) and falls into the collection reservoir (28).

As to other particular embodiments, the coils (26) can be cooled sufficiently such that liquid water derived from the water vapor within the chamber (3) forms proximate the coiled coils (26). Following, the liquid water can be collected from the coils (26), thereby removing the water extracted from the biomass (2) from the chamber (3).

Now referring primarily to FIG. 10, regarding the liquid water collection, as to particular embodiments, a condensate outlet port (29) can communicate with the chamber (3), whereby the condensate collected by the coils (26) can exit from the chamber (3) through the condensate outlet port (29) for collection into a collection reservoir (28). As to particular embodiments, a condensate collector (30) can be disposed below the coils (26) in angled relation such that the condensate collector (30) downwardly angles toward the condensate outlet port (29), the downward angle facilitating the travel of the condensate toward the condensate outlet port (29) and associated collection reservoir (28). Notably, this collection method may allow continuous removal of the condensate from the chamber (3) during the dehydration process, which may be advantageous for at least reducing the time and/or amount of energy required to complete the dehydration process.

As to particular embodiments, the dehydration apparatus (1) can further include one or more valves having locations and functions within the system as would be supposed by one of ordinary skill in the art.

As to particular embodiments, the dehydration apparatus (1) can further include one or more adjustment elements having locations and functions within the system as would be supposed by one of ordinary skill in the art. As but one illustrative example, a pressure adjustment element can be communicatively coupled to the vacuum generator (19) and can be effective to control the pressure within the chamber (3). As but a second illustrative example, a heat adjustment element can be communicatively coupled to the heat source (24) and can be effective to control the temperature within the chamber (3).

Similarly, as to particular embodiments, the dehydration apparatus (1) can further include one or more sensors having locations and functions within the system as would be supposed by one of ordinary skill in the art. As but one illustrative example, a pressure sensor can be operatively coupled to the chamber (3), whereby the pressure sensor can monitor the pressure within the chamber (3) and even communicate with the pressure adjustment element to control the pressure within the chamber (3). As but a second illustrative example, a temperature sensor can be operatively coupled to the chamber (3), whereby the temperature sensor can monitor the temperature within the chamber (3) and even communicate with the temperature adjustment element to control the temperature within the chamber (3). Usefully, both the pressure sensor and the temperature sensor can facilitate continuous adjustment of the respective pressure and temperature within the chamber (3) to maintain pre-selected conditions during the dehydration process.

As to particular embodiments, the dehydration apparatus (1) can further include a moisture sensor operatively coupled to the biomass (2) and/or the chamber (3), whereby the moisture sensor can monitor the moisture content of the biomass (2) and/or chamber (3).

As to particular embodiments, the dehydration apparatus (1) can further include a process controller (32), which may be configured for manual or automated control of one or more components of the dehydration apparatus (1). As to particular embodiments, the process controller (32) can include a display (33) configured for displaying any of a numerous and wide variety of process parameters, such as the pressure and the temperature within the chamber (3) during the dehydration process.

Now referring primarily to FIGS. 1 through 7, as to particular embodiments, the dehydration apparatus (1) can further include a support (34), such as one or more frames or housings, configured to support components of the dehydration apparatus (1) and/or position components of the dehydration apparatus (1) relative to one another.

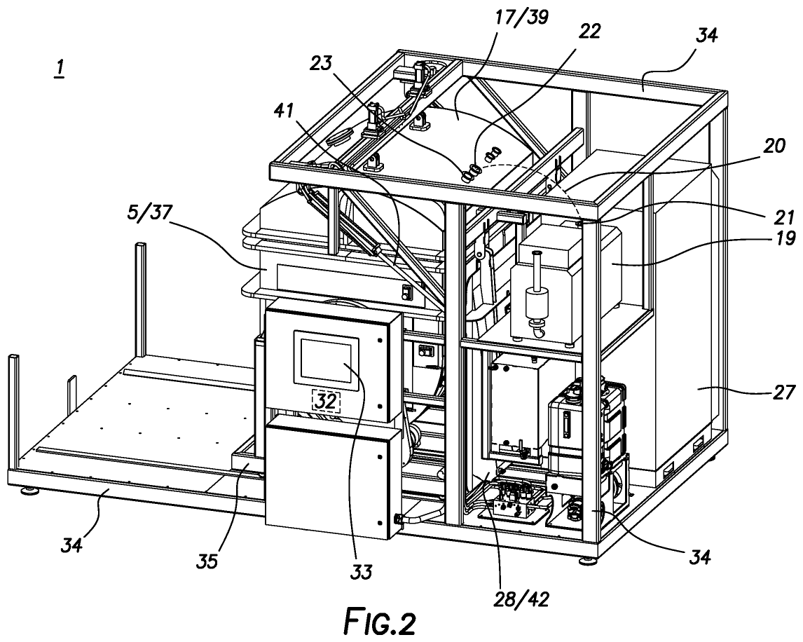

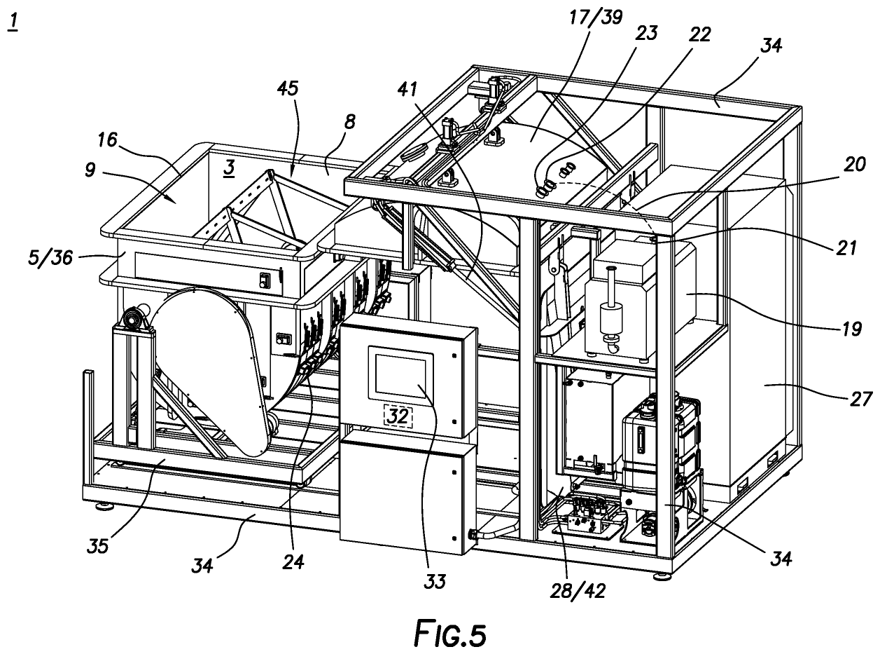

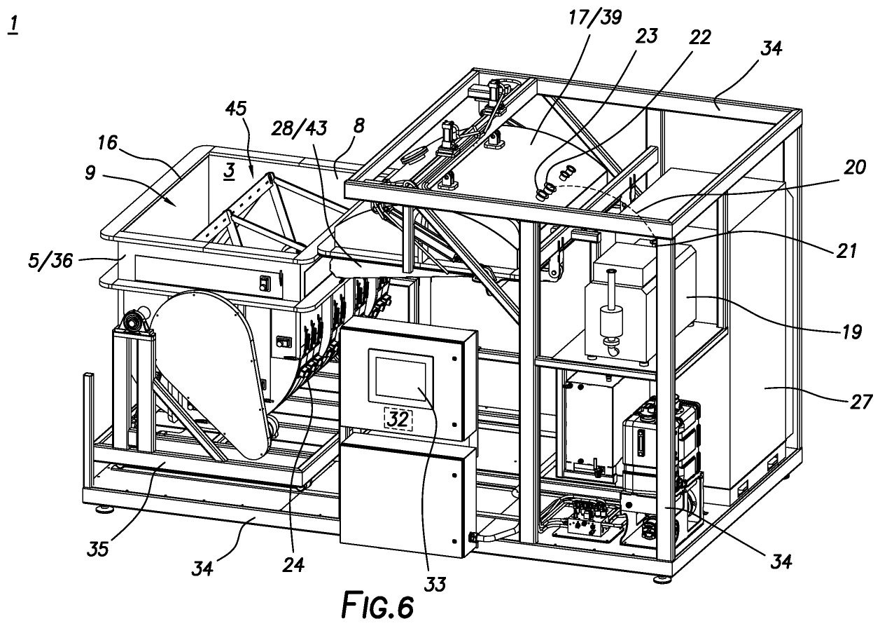

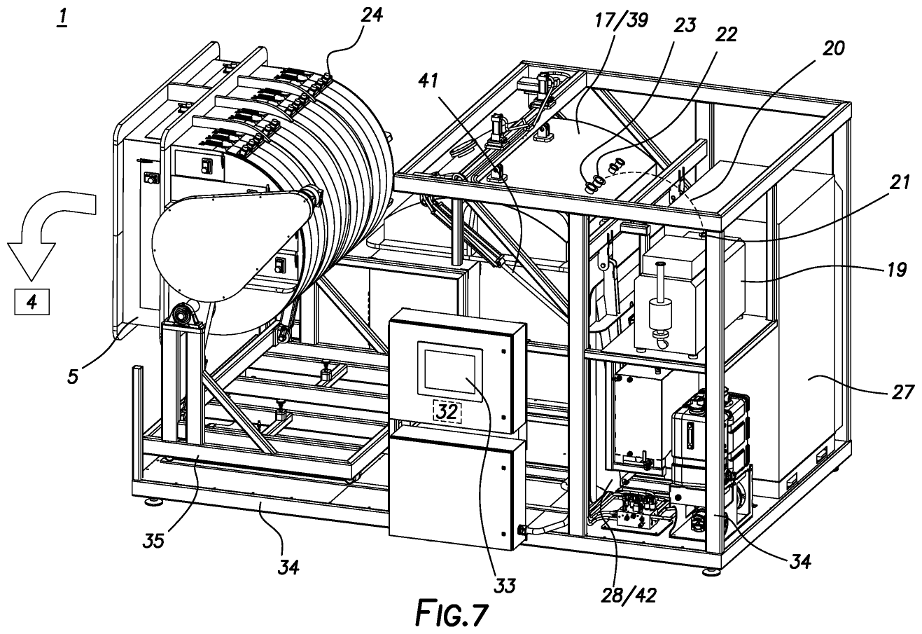

Now referring primarily to FIGS. 1, 2, and 7, the support (34) can facilitate movement of the vessel (5) in relation to the cover (17). For example, a first movable portion (35) of the support (34) can be coupled to the vessel (5) to facilitate generally horizontal movement of the vessel (5) relative to the cover (17). When in a vessel first position (36), the vessel (5) can dispose a sufficient horizontal distance from the cover (17) to allow loading of the biomass (2) into the chamber (3) (as shown in the example of FIG. 1) or unloading of the dehydrated biomass (4) from the chamber (3) (as shown in the example of FIG. 7). When in a vessel second position (37), the vessel (5) can (i) dispose below and (ii) vertically align with the cover (17) to facilitate closing of the vessel opening (9) to provide a closed chamber (3) for the dehydration process (as shown in the example of FIG. 2).

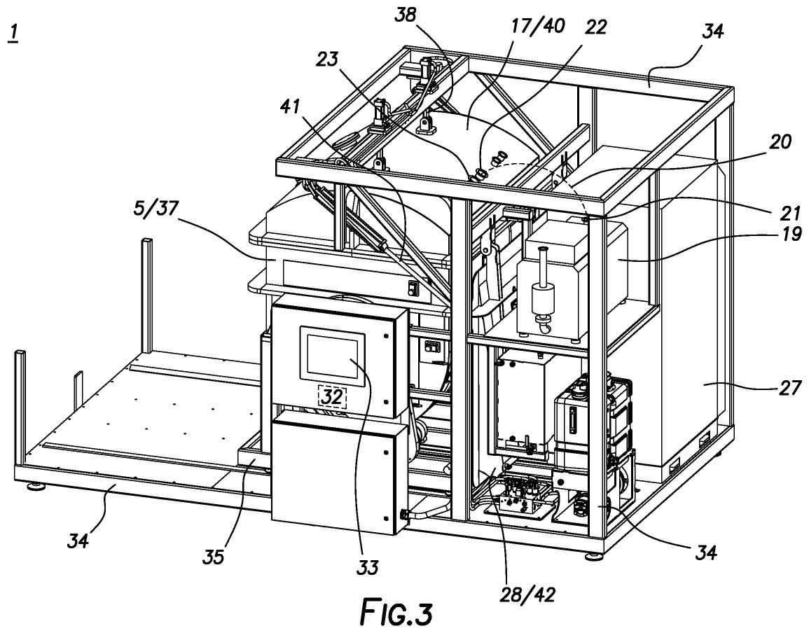

Now referring primarily to FIGS. 2, 3, and 4, the support (34) can further facilitate movement of the cover (17) in relation to the vessel (5). For example, a second movable portion (38) of the support (34) can be coupled to the cover (17) to facilitate generally vertical movement of the cover (17) relative to the vessel (5). When in a cover first position (39), the cover (17) can dispose in vertically spaced apart relation to the vessel (5) and in particular, to the vessel top portion (10) (as shown in the examples of FIGS. 2 and 4). When in a cover second position (40), the cover (17) can be lowered to sealably engage with the vessel top portion (10) to close the vessel opening (9) and provide a closed chamber (3) for the dehydration process (as shown in the example of FIG. 3).

Now referring primarily to FIGS. 5 and 6, the support (34) can further facilitate movement of the collection reservoir (28) in relation to the cover (17) and associated vapor collector (25). For example, a third movable portion (41) of the support (34) can be coupled to the collection reservoir (28) to allow pivotal movement of the collection reservoir (28) relative to the cover (17)/vapor collector (25). When in a collection reservoir first position (42), the collection reservoir (28) can dispose away from the cover (17)/vapor collector (25) (as shown in the example of FIG. 5). When in a collection reservoir second position (43), the collection reservoir (28) can dispose below the cover (17)/vapor collector (25) to permit collection of the water extracted from the biomass (2) during the dehydration process.

Now referring primarily to FIG. 7, the support (34) can further facilitate pivotal movement of the vessel (5), for example from a position in which the vessel opening (9) disposes upwardly to a position in which the vessel opening (9) disposes laterally or even downwardly, to assist with unloading of the dehydrated biomass (4) from the chamber (3).

As regards actuation, movement of one or more movable portions of the support (34) can be actuated by a variety of mechanisms, including hydraulic mechanisms.

As to particular embodiments, the dehydration apparatus (1) can be configured as a mobile unit which can be moved and located proximate a desired location, such as proximate a harvest of biomass (2).

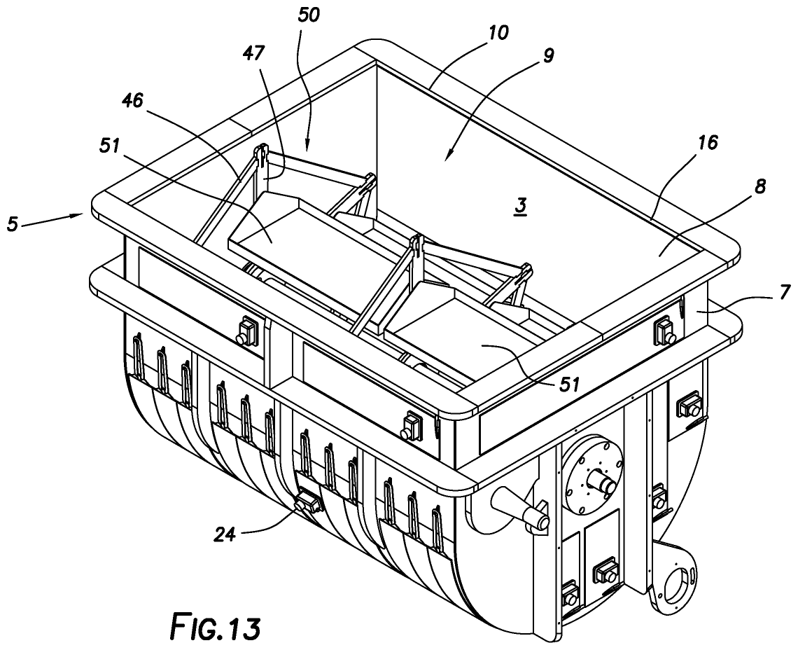

Now referring primarily to FIG. 11, as to particular embodiments, the dehydration apparatus (1) can further include an agitator (45) disposed within the chamber (3), whereby the agitator (45) can function to agitate the biomass (2) during the dehydration process. As to particular embodiments, the agitator (45) can include a frame (46), such as a circularly-shaped frame or a polygonally-shaped frame (which may include a plurality of spokes (47)), and one or more paddles (48) coupled or attached thereto (typically in spaced-apart relation to one another), whereby the frame (46) can rotate about a rotation axis (49), such as about a centrally-located, horizontal rotation axis, to correspondingly rotate the paddles (48) within the chamber (3) to agitate the biomass (2) disposed therein during the dehydration process.

As but one illustrative example, the agitator (45) can be configured as a paddle wheel; however and of course, the agitator (45) need not be limited to a paddle wheel configuration, and may be of any type which is suitable for agitating (or disturbing or moving around) the biomass (2) within the chamber (3) to practice the methods described herein. As to particular embodiments, the agitator (45) may also function to mix or blend the biomass (2) to form a relatively homogenous composition.

As to particular embodiments, the dehydration apparatus (1) can further include a reducer, such as a cutter and/or miller and/or grinder, disposed within the chamber (3) (not shown), whereby the reducer can be configured to reduce the size of the biomass (2) when disposed within the chamber (3). As to particular embodiments, reducing the size of the biomass (2) may be beneficial for the dehydration process and/or ensuing processes.

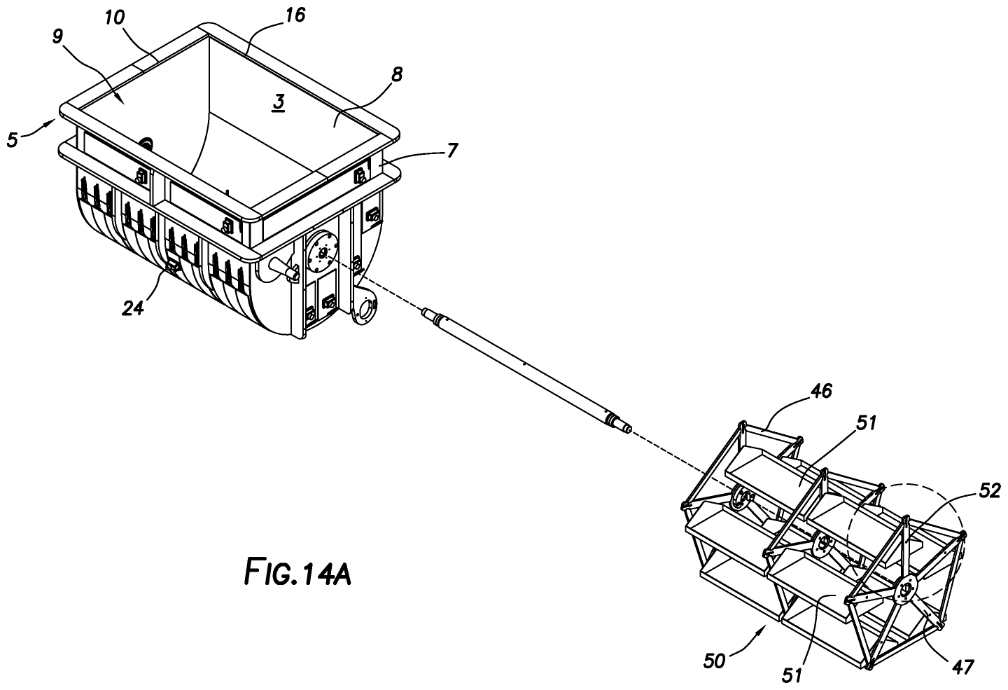

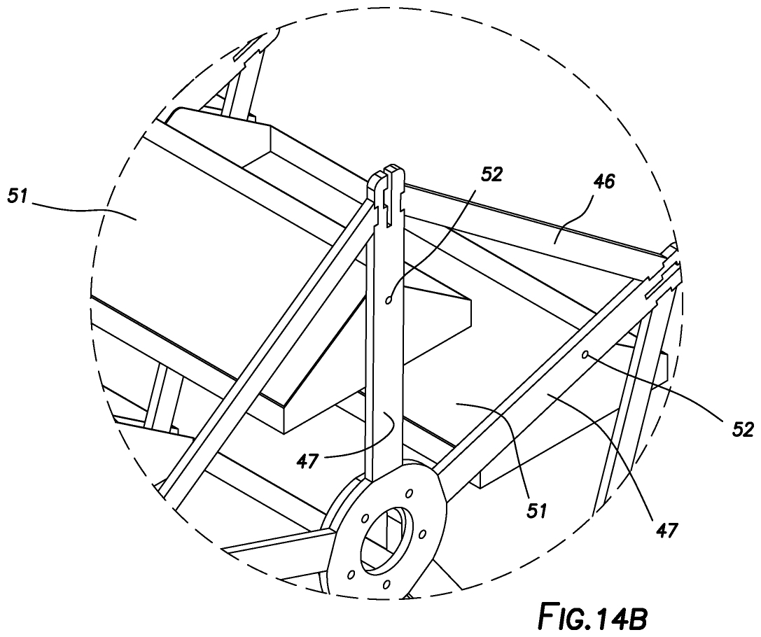

Now referring primarily to FIG. 13 through 14B, as to particular embodiments, the dehydration apparatus (1) can further include a spacer (50) disposed within the chamber (3), whereby the spacer (50) can function to space or separate the biomass (2) during the dehydration process. As to particular embodiments, the spacer (50) can include a plurality of containers (51) disposed within the chamber (3), whereby each container (51) can be configured to contain the biomass (2) during the dehydration process. As to particular embodiments, each container (51) can include a substantially-sized planar surface on which the biomass (2) can be spread out or spaced apart for dehydration, whereby such a configuration can be similar to or the same as a tray.

As to particular embodiments, the plurality of containers (51) can be coupled or attached to a frame (46), such as a circularly-shaped frame or a polygonally-shaped frame (which may include a plurality of spokes (47)), in spaced-apart relation to one another, whereby the frame (46) can rotate about a rotation axis (49), such as about a centrally-located, horizontal rotation axis, to correspondingly rotate the containers (51) within the chamber (3) to facilitate dehydration of the biomass (2) disposed therein. As to particular embodiments, each container (51) can be coupled to the frame (46) by an attachment element (52) configured to allow the container (51) to rotate and maintain a substantially horizontal position during rotation. As but one illustrative example, the attachment element (52) can include a pivot which allows the container (51) to pivot freely about the pivot point.

As to particular embodiments, the frame (46) may be compatible with interchangeable components, whereby as but one example, paddles (48) associated with the agitator (45), cutters or millers or grinders associated with the reducer, and/or containers (51) associated with the spacer (50) can be interchangeably coupled to the frame (46), depending upon the desired process within the chamber (3).

Regarding actuation, any one of the agitator (45), reducer, or spacer (50) can be moved, for example rotated, within the chamber (3) via any suitable drive mechanism, such as a hydraulic mechanism.

Concerning methodology, the instant method for dehydrating biomass (2) to a desired moisture content can be compatible with solid biomass (2). Said another way, the biomass (2) to be dehydrated can be loaded into the chamber (3) in its solid form, for example as milled or ground biomass (2).

As to particular embodiments, the initial moisture content of the biomass (2) to be dehydrated can in a range of between about 30% and about 60% and even upwards of about 65%, whereby the instant method can effectively produce dehydrated biomass (4) having a moisture content of between about 10% and about 15%.

Now referring primarily to FIGS. 1 and 12, the instant method can include disposing an amount of biomass (2) into the pressurizable chamber (3) of a vessel (5). As to particular embodiments, the vessel (5) and corresponding chamber (3) can be sufficiently sized for use with a large tote, super sack, or front-end loader.

Now referring primarily to FIGS. 2 and 12, if the above-described support (34) with movable portions is employed, the instant method can further include moving the vessel (5) from the vessel first position (36) to the vessel second position (37) to dispose the vessel (5) below the cover (17).

Now referring primarily to FIG. 12, the instant method can further include closing the vessel opening (9) to provide a closed chamber (3).

Now referring primarily to FIGS. 3 and 12, if the above-described support (34) with movable portions is employed, the instant method can further include moving the cover (17) from the cover first position (39) to the cover second position (40) to sealably engage the cover (17) with the vessel (5) to close the vessel opening (9) and provide the closed chamber (3).

Again referring primarily to FIGS. 3 and 12, the instant method can further include generating a sub-atmospheric pressure within the chamber (3) to vaporize water associated with the biomass (2).

Again referring primarily to FIGS. 3 and 12, as to particular embodiments, the instant method can further include providing thermal energy to the chamber (3) to facilitate the vaporization of the water associated with the biomass (2).

Again referring primarily to FIGS. 3 and 12, as to particular embodiments, the instant method can further include collecting the water extracted from the biomass (2) via the vapor collector (25).

As to particular embodiments whereby the vapor collector (25) facilitates the formation of liquid water from the water vapor, the liquid water collection can occur concurrently or simultaneously with the extraction of the water from the biomass (2) at a sub-atmospheric pressure (as shown in the example of FIG. 10). Following the collection of the water extracted from the biomass (2), the method can further include releasing the pressure within the chamber (3) and disengaging the cover (17) from the vessel (5) (as shown in the example of FIG. 4).

As to other particular embodiments whereby the vapor collector (25) facilitates the formation of solid water from the water vapor, if the above-described support (34) with movable portions is employed, the instant method can further include releasing the pressure within the chamber (3) and disengaging the cover (17) from the vessel (5) (as shown in the example of FIG. 4), and moving the collection reservoir (28) from the collection reservoir first position (42) (as shown in FIG. 5) to the collection reservoir second position (43) to dispose the collection reservoir (28) below the cover (17) and vapor collector (25) (as shown in the example of FIG. 6). Following, the method can further include melting the ice associated with the vapor collector (25) and collecting the corresponding liquid water from the vapor collector (25) into the collection reservoir (28). As to particular embodiments, more than one cycle of extracting the water from the biomass (2) and collecting the liquid water from the vapor collector (25) into the collection reservoir (28) may be necessary to achieve the desired moisture content of the dehydrated biomass (4). Accordingly, the method can include repeatedly generating a sub-atmospheric pressure with the chamber (3) to vaporize the water associated with the biomass (2), melting the ice associated with the vapor collector (25), and collecting the corresponding liquid water from the vapor collector (25) into the collection reservoir (28).

Now referring primarily to FIG. 12, the instant method can further include collecting the dehydrated biomass (4), whereby the dehydrated biomass (4) can then be stored or undergo additional processing.

It is worth mentioning that in addition to extracting water from the biomass (2), the instant method may also remove other compounds from the biomass (2) during the dehydration process, such as volatile terpenes and/or flavonoids.

As to particular embodiments, following dehydration, the dehydrated biomass (4) can undergo subsequent processing, which may also be carried out by one or more components of the instant dehydration apparatus (1). As but one illustrative example, the dehydrated biomass (4) can be subjected to an ethanol extraction within the closed chamber (3) to extract one or more ethanol-soluble components from the dehydrated biomass (2).

As to particular embodiments, with the instant dehydration apparatus (1), the ethanol extraction can be performed at ambient temperature, which may decrease the extraction time but increase the chlorophyll and/or waste content of the extracted product. As to other particular embodiments, the ethanol extraction can be performed at a temperature less than ambient, which may increase the extraction time but decrease the chlorophyll and/or waste content of the extracted product.

As to particular embodiments, with the instant dehydration apparatus (1), the agitator (45) can be employed during the ethanol extraction, which may decrease the extraction time and/or increase recovery of the extracted product.

As to particular embodiments, with the instant dehydration apparatus (1), the ethanol can be filtered to remove biomass waste and/or non-soluble matter.

As to particular embodiments, with the instant dehydration apparatus (1), the ethanol can be recovered following extraction, for example via vaporization and subsequent condensation at a sub-atmospheric pressure.

As to particular embodiments, with the instant dehydration apparatus (1), waxes and fats can be recovered from the filtrate.

As to particular embodiments, with the instant dehydration apparatus (1), an ethanol/oil mixture can be cooled for winterization, for example to a subzero temperature.

As to particular embodiments, with the instant dehydration apparatus (1), the ethanol can be recovered from the ethanol/oil mixture.

Naturally, additional processes may also be possible with the instant dehydration apparatus (1).

As can be easily understood from the foregoing, the basic concepts of the present invention may be embodied in a variety of ways. The invention involves numerous and varied embodiments of an apparatus for the dehydration of biomass, and methods for making and using such an apparatus.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or a method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “generator” should be understood to encompass disclosure of the act of “generating”—whether explicitly discussed or not—and, conversely, were there effectively disclosure of the act of “generating”, such a disclosure should be understood to encompass disclosure of a “generator” and even a “means for generating.” Such alternative terms for each element or step are to be understood to be explicitly included in the description.

In addition, as to each term used, it should be understood that unless its utilization in this application is inconsistent with such interpretation, common dictionary definitions should be understood to be included in the description for each term as contained in Merriam-Webster's Dictionary, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about”, it will be understood that the particular value forms another embodiment. The term “about” generally refers to a range of numeric values that one of skill in the art would consider equivalent to the recited numeric value or having the same function or result. Similarly, the antecedent “substantially” or “generally” means largely, but not wholly, the same form, manner or degree and the particular element will have a range of configurations as a person of ordinary skill in the art would consider as having the same function or result. When a particular element is expressed as an approximation by use of the antecedent “substantially” or “generally”, it will be understood that the particular element forms another embodiment.

Moreover, for the purposes of the present invention, the term “a” “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Thus, the applicant should be understood to claim at least: (i) each embodiment of the dehydration apparatus herein disclosed and described, (ii) the related methods disclosed and described, (iii) similar, equivalent, and even implicit variations of each of these apparatuses and methods, (iv) those alternative embodiments which accomplish each of the functions shown, disclosed, or described, (v) those alternative designs and methods which accomplish each of the functions shown as are implicit to accomplish that which is disclosed and described, (vi) each feature, component, and step shown as separate and independent inventions, (vii) the applications enhanced by the various systems or components disclosed, (viii) the resulting products produced by such systems or components, (ix) methods and apparatuses substantially as described hereinbefore and with reference to any of the accompanying examples, and (x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of embodiments of the invention and are not to be construed as the broadest embodiment of the invention or a complete listing of embodiments of the invention that may be claimed. The applicant does not waive any right to develop further claims based upon the description set forth above or in the drawings as a part of any continuation, division, continuation-in-part, or similar application.

1. A method for dehydrating biomass, comprising:
disposing an amount of biomass in a pressurizable chamber;
generating a sub-atmospheric pressure within said chamber; and
vaporizing water associated with said biomass to produce dehydrated biomass.

2. The method of claim 1, further comprising converting liquid water present in said biomass to water vapor.

3-32. (canceled)

33. The method of claim 2, wherein said biomass comprises cannabis plant biomass, and said dehydrated biomass comprises dehydrated cannabis plant biomass.

34. (canceled)

35. The method of claim 2, wherein said biomass comprises vanilla orchid plant biomass.

36-50. (canceled)

51. A biomass dehydrator comprising:
a vessel having a vessel internal surface which defines a pressurizable chamber;
a vacuum generator in fluid communication with said chamber, said vacuum generator configured to generate a sub-atmospheric pressure within said chamber to vaporize water associated with biomass disposed within said chamber; and
a vapor collector fluidicly coupled to said chamber.

52. The biomass dehydrator of claim 51, said vessel further comprising a vessel opening in communication with said chamber;
wherein matter can be passed through said vessel opening for ingress into or egress from said chamber.

53. (canceled)

54. The biomass dehydrator of claim 52, said vessel internal surface concave.

55-65. (canceled)

66. The biomass dehydrator of claim 52, further comprising a cover sealably engageable with said vessel to close said vessel opening and provide a closed chamber.

67-70. (canceled)

71. The biomass dehydrator of claim 52, said vacuum generator configured to decrease the pressure in said chamber to a pressure below about 760 torr.

72-74. (canceled)

75. The biomass dehydrator of claim 52, further comprising a heat source in thermal communication with said chamber, said heat source configured to provide thermal energy to facilitate vaporization of said water.

76-78. (canceled)

79. The biomass dehydrator of claim 52, wherein said vacuum generator functions as said vapor collector.

80. The biomass dehydrator of claim 52, said vapor collector configured as a condenser.

81-94. (canceled)

95. The biomass dehydrator of claim 52, further comprising an agitator disposed within said chamber, said agitator configured to agitate said biomass during dehydration of said biomass.

96. The biomass dehydrator of claim 95, said agitator comprising:
a frame; and
a plurality of paddles coupled to said frame in spaced apart relation;
said frame and said paddles rotatable about a rotation axis.

97. (canceled)

98. The biomass dehydrator of claim 52, further comprising a spacer disposed within said chamber, said spacer configured to space said biomass during dehydration of said biomass.

99. The biomass dehydrator of claim 98, said spacer comprising:
a frame; and
a plurality of containers coupled to said frame in spaced apart relation;
said frame and said containers rotatable about a rotation axis.

100. The biomass dehydrator of claim 99, said containers pivotally coupled to said frame to allow said containers to maintain a substantially horizontal position during rotation.

101-104. (canceled)

105. The biomass dehydrator of claim 52, further comprising a support configured to support one or more components of said biomass dehydrator, said support comprising one or more movable portions.

106-120. (canceled)

121. The biomass dehydrator of claim 52, wherein said biomass comprises cannabis plant biomass.

122. The biomass dehydrator of claim 52, wherein said biomass comprises vanilla orchid plant biomass.
